(19) United States
(12) Patent Application Publication
(10) Pub. No.: US 2003/0202906 A1
(43) Pub. Date: Oct. 30, 2003

(54) Adding the amperage of the conductive film of the biosensor

(76) Inventor: Ching-Hsin Cho, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/128,274

(22) Filed: Apr. 24, 2002

(51) Int. Cl. G01N 27/00

(52) U.S. Cl. 422/82.01; 422/82.02; 435/14; 435/817; 204/400; 204/403.01; 204/403.04; 204/403.11; 204/403.14

(57) ABSTRACT

A biosensor device for adding the amperage of the conductive film, the biosensor comprises a base comprising a first base and a second base and both those be clapped to each other and said second base be located a test hole; a electrode film comprising a first electrode film and a second electrode film, said first electrode be located on said first base and including a anode electrode film and a cathode electrode film and said second electrode film be located on the second base and located the side of side test hole; a conductive film be located on said first base, including a anode and cathode conductive film of phase separation; a bioactive layer be located on the said first electrode film to form a active area that at least covering a portion of said anode and cathode electrode film; and a adhesive layer connected between said first base and said second base to adhere said first base and said second base that said test hole of it corresponded to said active area of said first base.

### FIELD OF THE INVENTION

The present invention relates to the biosensor, more particularly, to a biosensor device for adding the amperage of the conductive to elevate the accuracy of the blood sugar measurement.

### BACKGROUND OF THE INVENTION

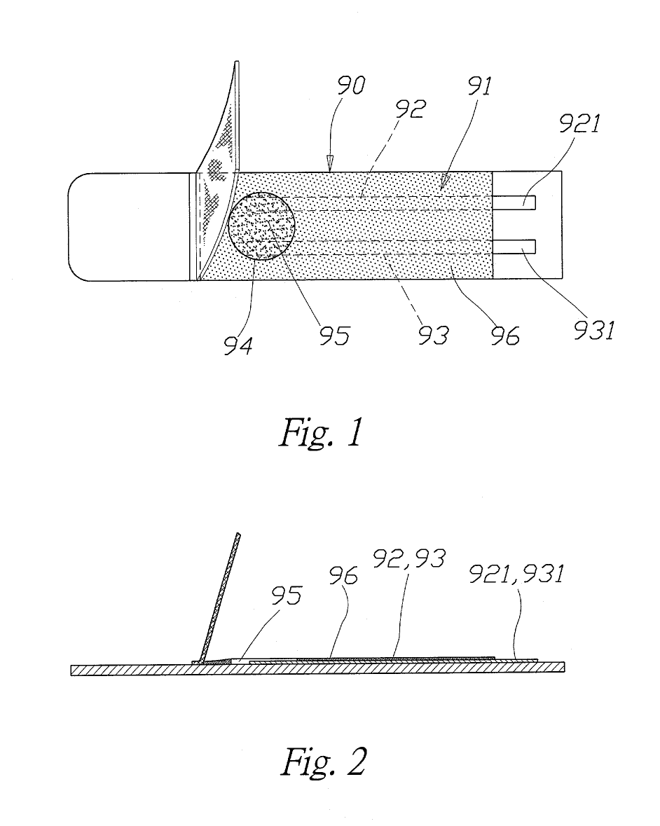

The test, convention, of blood sugar used to a amperometric biosensor. The concentration of the blood sugar is tested, the inspection such as blood is trickled on the amperometric biosensor to be generated electrons by oxidation reduction reaction, by the electrons that is measured and analyzed by a sensor. Referring to FIGS. 1, 2 of prior art, the amperometric biosenor comprises a slice base 90 that includes a conductive film 91, consists of individual anode 92 and cathode 93 assemblies and includes a workspace 94 being a circle area to cover the anode 92 and cathode 93 assemblies and painted on a bio-active layer. The base 90 is that one side is the conductive file 91 and the other side to opposite for the conductive film 91 is a isolation layer 96 to be printed. The isolation layer 96 could not cover the area of the anode assembly 92, a cathode assembly 93, a anode contact region 921 and a cathode contact region 931. The neighborhood of the workplace 94 is adhered a reticulum 97. When the inspection is tricked on the workplace 94, the glucose of the inspection reacts with the bioactive layer 95 to release the electrons. The electrons are conved form the conductive film 91 to the sensor that determined the value of the blood sugar. The contact area of the electrons and the conductive film91 are rather small design for the structure of the biosensor and the instantaneous carrying-current of the conductive film 91 is small it. It can not to measure for the value, analyzed, of the sensor to effect the precise of the test.

### BRIEF SUMMARY OF THE INVENTION

It is therefore an object of the present invention to provide a biosensor device for the accuracy of the blood sugar.

It is another object of the present invention to provide a biosensor device capable of offering the larger contact area of the electrode to make the conductive film carry rather large instantaneous carrying-current, adding accuracy of the biosensor.

### BRIEF DESCRIPTION OF THE INVENTION

The objects, spirits and advantages of the preferred embodiments of the present invention will be readily understood by the accompanying drawings and detailed description, wherein:

FIG. 1 is a schematic showing a conventional biosensor;

FIG. 2 is a perspective drawing a conventional biosensor;

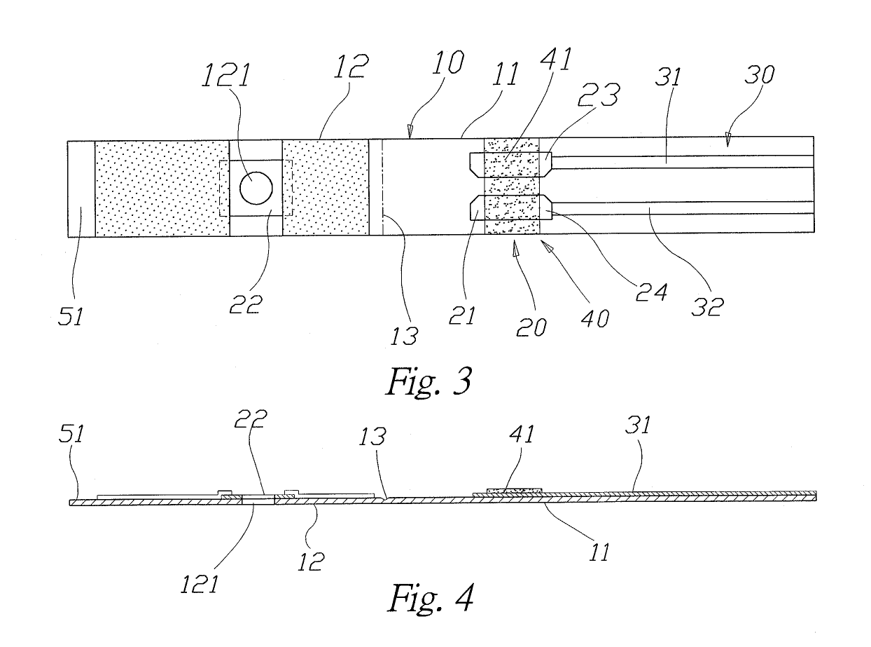

FIG. 3 is a front view of a biosensor according to the present invention

FIG. 4 is a perspective drawing of a biosensor according to the present invention;

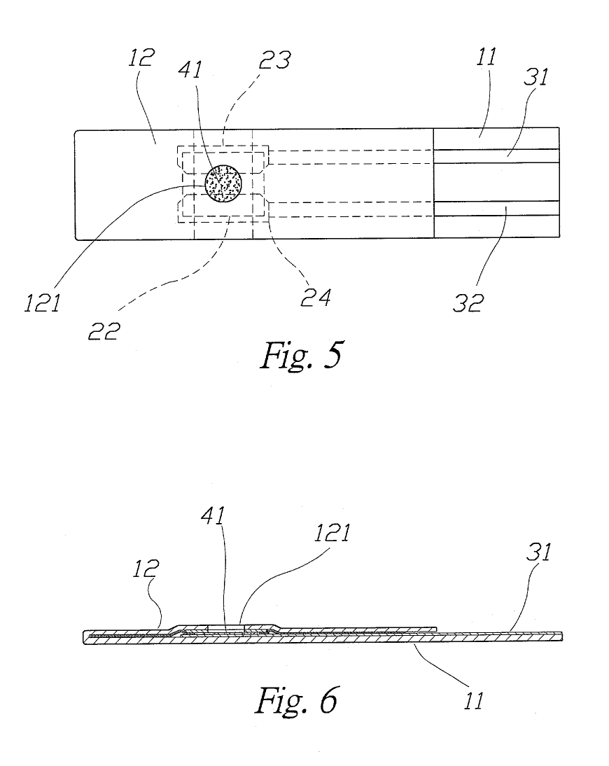

FIG. 5 is a schematic showing after assembling of a biosensor according to the present invention and

FIG. 6 is a perspective drawing after assembling of a biosensor according to the present invention.

### DETAIL DESCRIPTION OF THE PREFERRED EMBODIMENT

Referring to FIGS. 3 and 4, the biosensor comprises a base 10, a electrode film 20, a conductive film 30, a bioactive layer 40 and adhesive layer 50. The base 10 includes a first base 11 and a second base 12 and there is located a broken line between the first base 11 and the second base 12, it is clapped to the first base 11 and it is shorter than the first base11 that is located a test hole 121. The first electrode film 20 comprises a first electrode film 21, located on the first base 11 and including a anode electrode film 23 and cathode electrode film 24, and a second electrode film 22 that is located on the second base 12, located on side of the test hole 121. The conductive film 30 located the first base 11 comprises a anode 31 and cathode 32 conductive film of phase separation. The bioactive layer located on the first electrode film 21 is formed a active area 41, covering the anode 13 and cathode 15 electrode film. The composition of the bioactive layer 40 comprises:

1. The enzyme is a glucose oxidase.

2. The enzyme protectant is selected from albumin, dextrin, dextran and amino acid.

3. The conductive dielectric is potassium.

4. The surfacant is selected from TritonX-100, TritonX-405, TritonX-114, sodium lauryl sulfate, polyoxethlenesorbitan monolaurate(Tween 20), Tween 40, Tween 60, Tween 80, others water-soluble surfactant and cleaner.

5. The buffer solution is a salt such as phosphate buffer solution.

6. The water is a purify water form distillation.

And trickled to being formed the active area 41, the active correspondence area 16 to the active area 41 of the second base 12 is matched, when the first base 11 clapped to the second base 12, and do not be covered the workplace 51 of side of the active correspondence area 16.

Referring to FIGS. 5 and 6, according to the broken line 13 when the first base 11 is clapped to the second base 12 and adhered by the adhesive layer 50. And, the test hole 121 of the second base 12 is correspond to the active area 41 of the first base 11 and the denuding of the anode 31 and cathode 32 conductive film. When being tested the blood sugar for the inspection such as blood by the biosensor, the inspection is trickled to the test hole 121 and it is reacted with the bioactive layer 40 of the active area 41 to relieve electrons. The electrons active between the electrode film 20 and the conductive film 30 and further used sensor for analyzing the value of the instantaneous carrying-current.

The advantage of the present invention for elevating the accuracy of the biosensor by adding the contact area for the electron and the electrode film 20.

I claimed:

1. Adding the amperage of the conductive film of the biosensor, said biosensor comprising:
a base comprising a first base and a second base and both those be clapped to each other and said second base be located a test hole;
a electrode film comprising a first electrode film and a second electrode film, said first electrode be located on said first base and including a anode electrode film and a cathode electrode film and said second electrode film be located on the second base and located the side of side test hole;
a conductive film be located on said first base, including a anode and cathode conductive film of phase separation;
a bioactive layer be located on the said first electrode film to form a active area that at least covering a portion of said anode and cathode electrode film; and
a adhesive layer connected between said first base and said second base to adhere said first base and said second base that said test hole of it corresponded to said active area of said first base.

2. The biosensor of claim 1, wherein there is located a broken line between said first base and second base to convenience being clapped.

3. The biosensor of claim 1, wherein said second base is shorter than said second base.

4. The biosensor of claim 1, wherein said bioactive layer comprises enzyme, enzyme protectant, conductive dielectric, surfactant, buffer solution and water.

5. The biosensor of claim 4, wherein said enzyme is glucose oxidase.

6. The biosensor of claim 4, wherein said enzyme protectant is selected from albumin, dextrin, dextran and amino acid.

7. The biosensor of claim 4, wherein said conductive dielectric is potassium.

8. The biosensor of claim 4, wherein said surfactant is selected form TritonX-100, TritonX-405, TritonX-114, sodium lauryl sulfate, polyoxethlenesorbitan monolaurate(Tween 20), Tween 40, Tween 60, Tween 80, others water-soluble surfactant and cleaner.

9. The biosensor of claim 4, wherein said buffer solution is phosphate buffer solution.

10. The biosensor of claim 4, wherein said water is a purified water from distillation.

11. The biosensor of claim 1, wherein said adhesive layer is located on said second base.

12. The biosensor of claim 11, wherein said adhesive layer is eschewed said active area of said second base.
